(19) United States
(12) Patent Application Publication
(10) Pub. No.: US 2004/0123470 A1
(43) Pub. Date: Jul. 1, 2004

(54) Bias adjustable scraping tool

(76) Inventor: Thomas C. Gray, Clarkston, WA (US)

Correspondence Address: FREDERICK GOTHA ESQ., SUITE 823, 80 S. LAKE AVE., PASADENA, CA, 91101, US

(21) Appl. No.: 10/331,580

(22) Filed: Dec. 30, 2002

(51) Int. Cl. B26B 3/00

(52) U.S. Cl. 30/169

(57) ABSTRACT

This invention consists of a bias adjustable impact scraping tool that has a bias spring selectively positionable in a first region or a second region respectively for biasing or un-biasing a cutting blade for scraping material from surfaces when the surface is above or below the cutting blade. A ramming member for transmitting externally applied thrust forces to a scraping member is telescopically and slidably mounted to the scraping member which may be biased or un-biased relative to the ramming member by selectively positioning the bias spring. A removably mounted partition sleeve located within the ramming member partitions the ramming member into first and second regions. When the bias spring is held within the first region, the scraping member is biased by the bias spring to remain distally extended during a thrust cycle of the tool thereby urging the cutting blade to remain in contact with the surface. For scraping surface material below the cutting blade, by removing the partition sleeve, repositioning the bias spring in the second region and re-inserting the partition sleeve, the operator un-biases the scraping member and prolongs the life of the tool.

In another embodiment, a handle portion removeably coupled to the ramming member compresses a bias spring which is slideably disposed within the ramming member against a scraping member to urge a cutting blade against the scraping surface. The diameter of the bias spring is less than the internal diameter of the ramming member and upon removal of the handle portion, the bias spring is slideably removed therefrom. The handle portion utilizes a compression button and leaf spring to permit removeable coupling to the ramming member.

### FIELD OF THE INVENTION

This invention relates to a scraping tool which is bias adjustable for facilitating scraping of various types of materials either from floors or overhead surfaces.

### BACKGROUND OF THE INVENTION

To facilitate the removal of linoleum, ceramic tile, adhesive plastics, barnacles or other build-up on various surfaces, whether on an overhead surface, floor, or inclined surface, it is desirable to maintain the cutting edge of an impact scraping tool that utilizes a ramming member in bearing contact with the material to be removed throughout the scraping cycle. When the material is below the cutting edge of the impact scraper, gravitational forces assist in maintaining bearing contact of the cutting edge with the surface; however, removing material from overhead or inclined surfaces is virtually unworkable unless the blade is biased against the surface since the scraping blade of the tool is below the surface and cannot remain in bearing contact with the material as the ramming member is retracted for a subsequent blow.

The prior art discloses, U.S. Pat. No. 2,485,877, a lawn edging instrument that utilizes a spring to bias the blade which acts upon the blade regardless of the orientation of the tool. Thus, for each blow delivered by the tool, the spring is compressed and the life of the tool substantially shortened. It is therefore desirable to provide an adjustable bias scaping tool to prolong the life of the tool by unbiasing the scraping member when the material is below the blade.

### SUMMARY OF THE INVENTION

The present invention is directed to a bias adjustable impact scraping tool that utilizes a ramming member for applying an axially directed thrust force to a scraping member. The ramming member is slidably and telescopically mounted to the scraping member and has an internal chamber region located intermediate its ends. A partition means is removeably carried by the ramming member for partitioning the chamber region into a first region and a second region. In the preferred embodiment of this invention, the partition means is a bolt that laterally extends and threads into an opposing sleeve to partition the chamber region of the ramming member. The partition means permits the scraping member to be carried by the ramming member in either a biased or unbiased mode by a bias means. In the preferred embodiment, the bias means is a spring. When the spring is captively held in the second region by the partition member, the scraping member is unbiased or in the unbiased mode; alternatively, when the bias means is captively held in the first region, the scraping member will be biased against the ramming member thereby urging the scraping member to return to full extension with respect to the ramming member. The ramming member is thus biased by the bias means or spring against the thrust member throughout the operation of the tool if the bias means is captively held in the first region and unbiased throughout the operation of the tool if captively held in the second region.

In the preferred embodiment of this invention, a scraping member has a longitudinal axis and an axially extending void therethrough, a distal end and a proximal end, and an axially extending slot intermediate the distal and proximal ends where the slot communicates with the axially extending void. Adjacent the distal end of the scraping tool, a cutting blade is removeably mounted to the scraping tool for removal of surface materials. The scraping member is mounted in slidable telescopic relationship with a ramming member for relative axial displacement with respect to the ramming member. A chamber region is contained intermediate the ends of the ramming member and the chamber region is partitioned by a removeably mounted partition member into a first region and a second region. The ramming member has a laterally extending guide member that extends into the axially extending slot of the scraping member such that the ramming member and scraping member are coupled in fixed rotational relationship and slidable axial relationship. A bias spring is selectively and moveably carried by the ramming member in either a bias relationship with the scraping member when the bias spring is captively disposed in the first region or unbiased when captively disposed in the second region. To transfer the momentum of the ramming member to the scraping member, a barrier region associated with the ramming member and scraping member precludes continued axial movement in the thrust direction of the ramming member during a thrust movement. The bias member or spring bears against both the ramming member and scraping member when the bias spring is carried in the first region of the chamber region; thus, the momentum of the ramming member is transferred to the scraping member as the ramming member compresses the spring and is stopped by engagement with the barrier. When the bias spring is carried in the second region, the spring remains uncompressed throughout the use of the tool.

In another embodiment of this invention, a bias spring is selectively removeable from the scraping tool to permit the tool to be used to remove surface material above or below the scraping blade. When the material is above the blade, the ramming member carries the bias spring in bias relationship with a removeably mounted handle portion which bears against the bias spring biasing the scraping member toward an extended distal position. To unbias the scraping member from the ramming member for removing surface material below the scraping blade, the handle portion is removed from the ramming member and locked into fixed relationship with the ramming member. With the bias spring removed from the tool, the scraping blade is unbiased and remains in bearing contact with the surface beneath it through gravitational forces as the ramming member is withdrawn for another impact.

### BRIEF DESCRIPTION OF THE DRAWINGS

These and other features and advantages will become appreciated as the same become better understood with reference to the following specification, claims and drawings wherein:

FIG. 1 is an exploded perspective view of the adjustable bias scraping tool according to the present invention;

FIG. 2 is a part cross-sectional view of FIG. 1 illustrating the ajustable bias scraping tool in a biased mode.

FIG. 3 is a part cross-sectional view of FIG. 1 illustrating the ajustable bias scraping tool in an unbiased mode.

FIG. 4 is a part cross-sectional view of another embodiment of this invention for permitting selective removal of the bias means.

### DETAILED DESCRIPTION

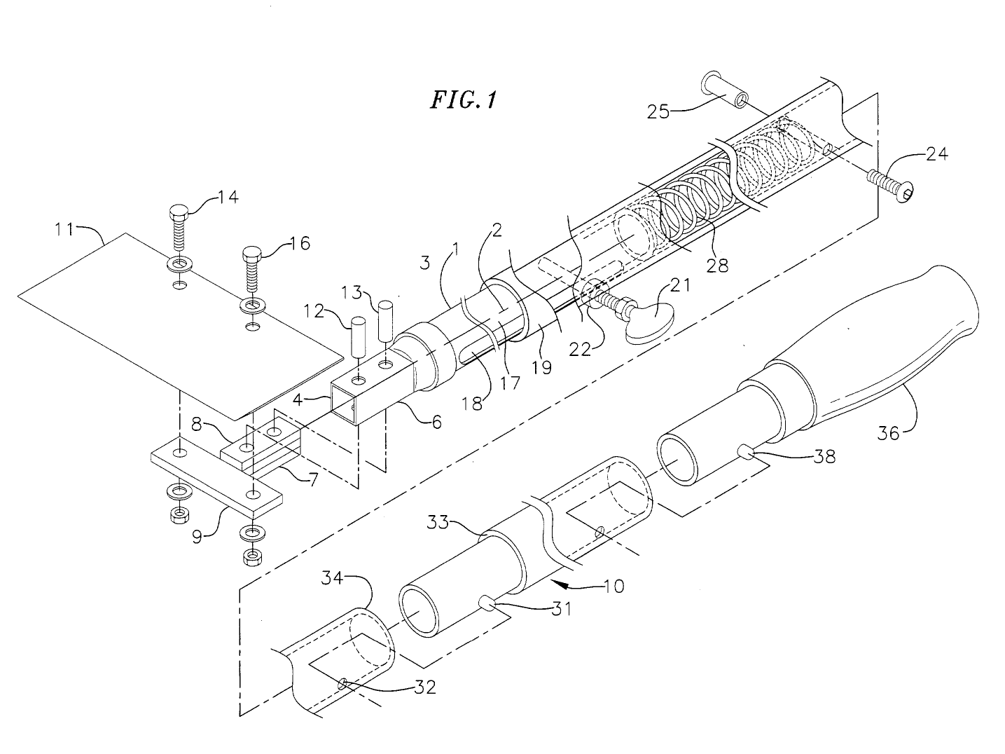

An exploded perspective view of the bias adustable scraping tool 10 of this invention is shown in FIG. 1. As can be seen in FIG. 1, scraping member 1 has a longitudinal axis 2 and a barrier member 3 carried in fixed relationship with scraping member 1. At the distal end 4 of the scraping member, a tubular member 6 extends distally to form a housing structure for blade clamps 7 and 8 and T-clamp 9; this structure forms the clamping mechanism for cutting blade 11. Blade clamps 7 and 8 sandwich T-clamp 9 and as can be seen in FIG. 1, blade clamps 7 and 8 and T-clamp 9 are fixed to tubular member 6 by rivet fasteners 12 and 13. The clamping mechanism permits cutting blade 11 to be removeably held in fixed relationship with scraping member 1 by fasteners 14 and 16 which fasten cutting blade 11 to T-clamp 9. A bias spring 28, which is selectively positionable by the operator, permits the operator to selectively determine whether to apply a biasing force to the scraping tool. When scraping member 1 is biased toward the thrust direction of the tool, if cutting blade 11 is positioned for an upward thrust against an overhead surface, bias spring 28 will exert a force against scraping member 1 such that bearing engagement is retained with the overhead surface throughout the thrust motion of scraping member 1.

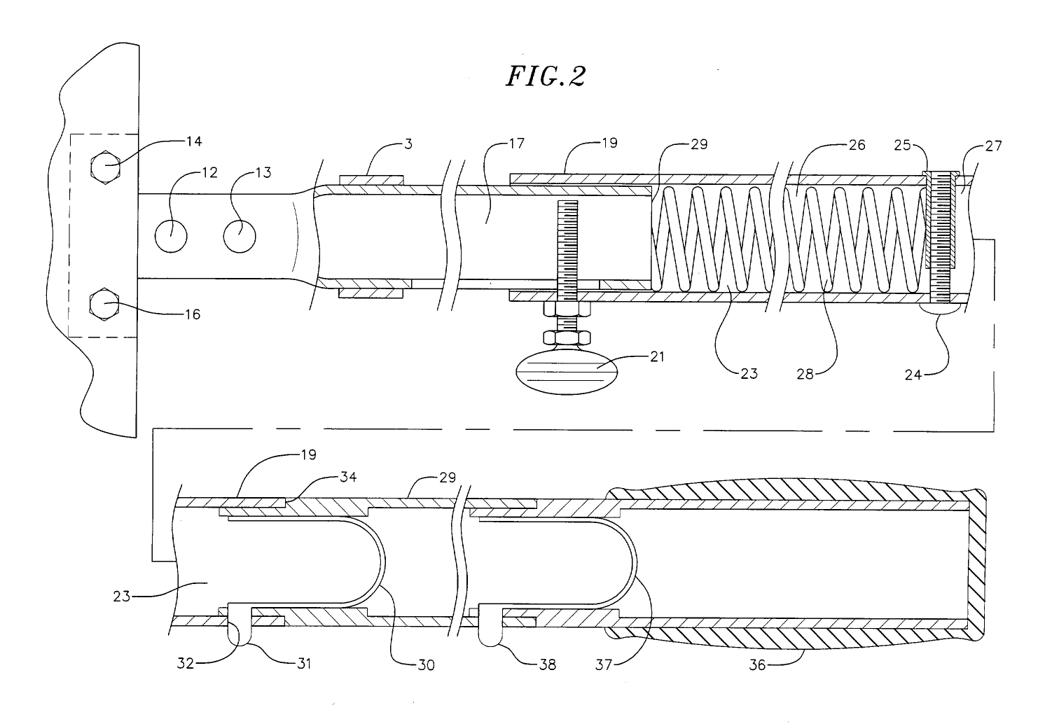

Referring to FIG. 2, the construction of the bias adjustable tool that permits the scraping member to be selectivly biased is shown. As can be seen in FIG. 2, ramming member 19 has an axially extending internal cavity 23 that is partitioned by a removable, laterally extending fastener 24, and partition sleeve 25 that partitions ramming member 19 into a first region 26 and a second region 27. Bias spring 28, when disposed within first region 26, bears against the proximal end 29 of scraping member 1 and against partition sleeve 25 thereby urging scraping member 1 to remain distally extended. When fastener 24 and partition sleeve 25 are removed from internal cavity 23 and bias spring 28 is disposed within second region 27, and thereafter fastener 24 and partition sleeve are re-inserted into internal cavity 23, scraping member 1 is disengaged from bearing engagement with bias spring 28 thereby unbiasing cutting blade 11 and unbiasing scraping member 1 from ramming member 19. Thus, by removal of fastener 24 and partition sleeve 25, the operator of the bias adustable tool can selectively dispose bias spring 28 in either first region 26 or second region 27 to bias or unbias scraping member 1. Bias spring 28 has an outer diameter that is less than the internal diameter of internal cavity 23 and is therefore easily positioned in either the first or second region.

As further illustrated in FIG. 1, scraping member 1 is of cylindrical construction with an axially extending internal bore 17 and an axially extending slot 18 that communicates with internal bore 17. Scraping member 1 is coupled to ramming member 19 by key 21 which extends into slot 18 forming a quide means 32 to permit relative telescopic sliding movement between scraping member 1 and ramming member 19 thus permitting slidable axial movement while in fixed rotational relationship.

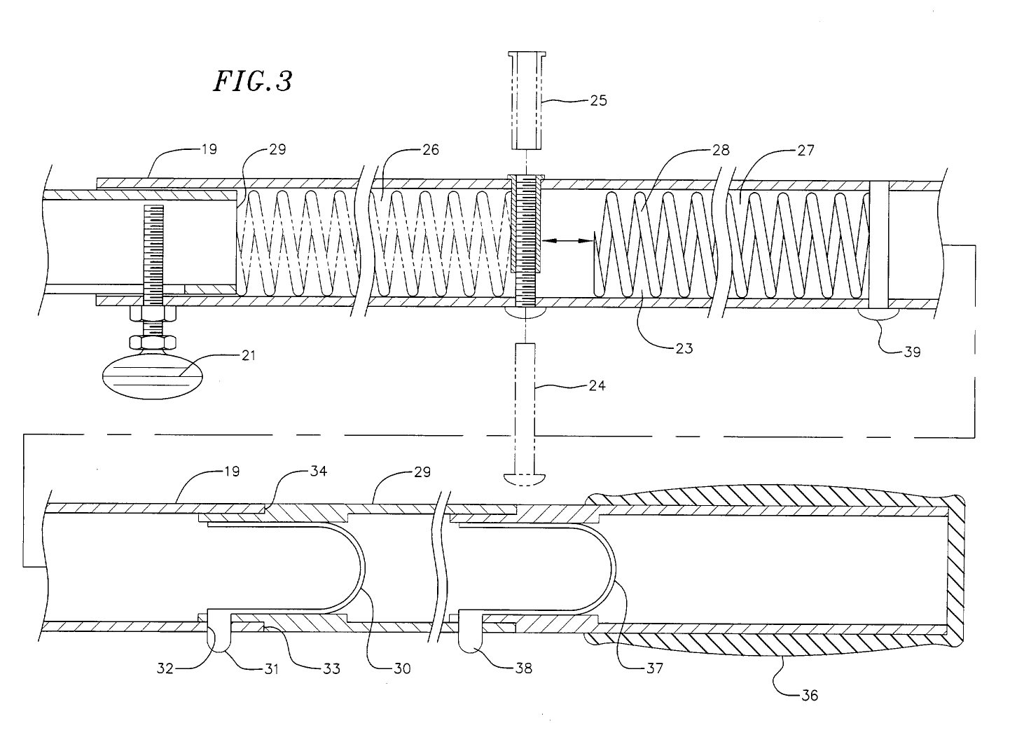

The preferred embodiment of this invention is shown in FIGS. 1-3. FIG. 2 illustrates the bias spring 28 when disposed in the first region 26 and FIG. 3 illustrates bias spring 28 disposed in second region 27. Thus, if surface material is to be removed from a surface which is above cutting blade 11, the operator removes fastener 24 and partition sleeve 25 and disposes bias spring 28 into first region 26 and thereafter re-inserts fastener 24 and partition sleeve 25; scraping member 1 is thereby biased toward a distally extended position. By biasing scraping member 1, the operator permits cutting blade 11 to remain in bearing contact with the surface throughout the axially thrusting cycles of ramming member 19. When the surface material or surface is below cutting blade 11, by removing fastener 24 and partition sleeve 25, the operator may position bias spring 28 in second region 27, re-insert the fastener and partition sleeve thereby placing the the bias adjustable tool in the unbiased mode. In this mode, gravitational forces assist in retaining bearing contact between the cutting blade and surface during thrust cycles of the ramming member.

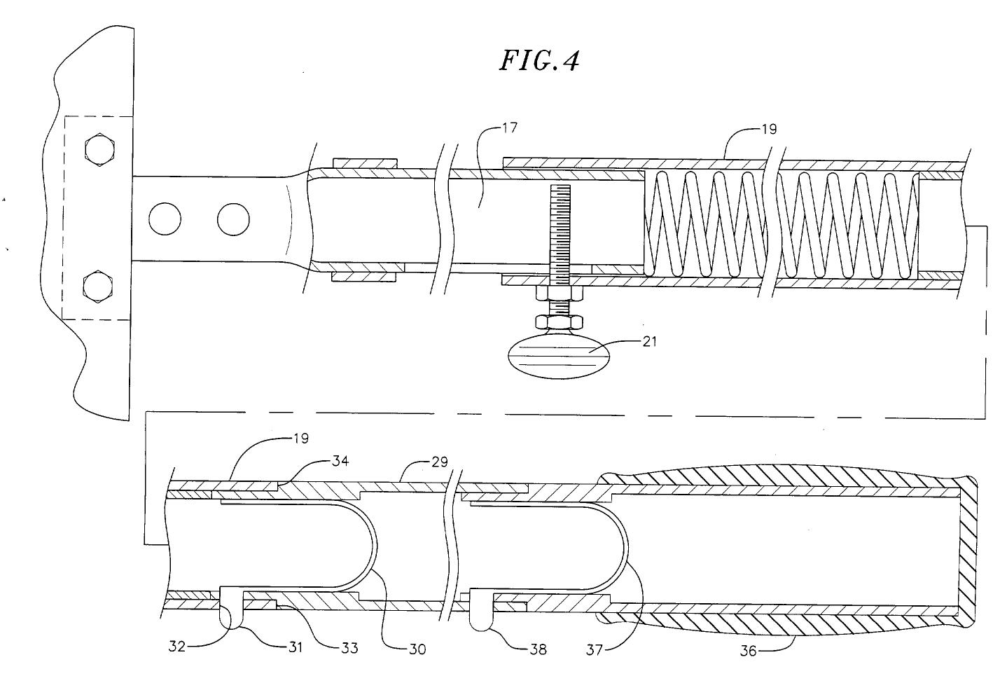

In another embodiment of this invention, bias spring 28 is removeably mounted within internal cavity 23 by handle portion 28. Handle portion 28 is detachable from ramming member 19 by leaf spring 29 which is carried in fixed relationship with handle portion 28 and is positioned within cavity 23. Leaf spring 29 permits the handle portion to unlock and detach from the ramming member when compression head 30 is pushed radially a sufficient distance through orifice 31 until leaf spring 29 is within cavity 23. When handle portion is withdrawn from telescopic relationship with scraping member 1, bias spring 28 can be removed from the bias adjustable tool. This is accomplished by permitting bias spring 28 to slide proximally through and out of cavity 23. After bias spring 28 is removed, handle portion 29 is re-inserted into internal cavity 23 until shoulder 33 of the handle portion abuts against the proximal end 34 of the ramming member 19. Both the ramming member and the housing member are so constructed that upon shoulder 33 and proximal end 34 engaging, compression head 31 will align with and snap into orifice 32 to lock the handle portion to the ramming member. In this embodiment, as can be seen in FIG. 4, proximal handle 36 is removeably carried by the handle portion by the identical locking construction as that shown for removeably locking the handle portion to the ramming member. Second leaf spring 37 having a second compression head 38 locks proximal handle 36 in fixed axial and rotational relationship with handle portion 29.

Thus, I have shown a bias adustable tool that extends the life of the tool by selectively enabling the operator to unbias the cutting blade when the scraping surface material is below the cutting blade or to bias the blade to retain engagement throughout the thrusting cycles of the tool with the surface when the surface is above the blade.

While I have shown a preferred embodiment of the present invention, it is to be understood that it is subject to many modifications without departing from the scope and spirit of the claims as recited herein.

What is claimed is:

1. A bias adjustable impact scraping tool for scraping material from surfaces, comprising:
(a) a scraping member having a longitudinal axis;
(b) a ramming member having an axis of elongation mounted in slidable telescopic relationship with said scraping member, said ramming member having a chamber region contained therein;
(c) partition means removeably carried by said ramming member for partitioning said chamber region into a first region and a second region;
(d) a bias means for axially biasing said scraping member and said ramming member when said bias means is disposed in said first region and where said scraping member is unbiased when said bias means is disposed in said second region; and
(e) a barrier region associated with said ramming member and said scraping member for precluding relative slidable movement between said ramming member and said scraping member when said ramming member is in bearing relationship with said barrier region.

2. The bias adjustable impact scraping tool recited in claim 1 further comprising a guide means associated with said scraping member and said ramming member for coupling said scraping member and said ramming in fixed rotational relationship while permitting slidable axial relative movement between said scraping member and said ramming member.

3. The bias adjustable impact scraping tool recited in claim 1 were said scraping member has a distal end, a distal end and a proximal end, said scraping member further comprising a scraping blade removeably carried by said scraping member adjacent said distal end.

4. The bias adjustable impact scraping tool recited in claim 3 where said guide means comprises an axially extending slot intermediate said distal and proximal ends of said scraping member and a guide member extending laterally into said said slot, where said guide member is carried in fixed relationship with said ramming member.

5. The bias adjustable impact scraping tool recited in claim 1 where said bias means comprises a spring.

6. The bias adjustable impact scraping tool recited in claim 1 further comprising a handle removeably carried by said ramming member.

7. The bias adjustable impact scraping tool recited in claim 1 where said partition means comprises a fastener system extending laterally within said ramming member.

8. In combination:
(a) a scraping member having a longitudinal axis;
(b) a ramming member having an axis of elongation mounted in slidable telescopic relationship with said scraping member, said ramming member having a chamber region contained therein;
(c) a partition means removeably carried by said ramming member for partitioning said chamber region into a first region and a second region;
(d) a bias means for axially biasing said scraping member and said ramming member when said bias means is disposed in said first region and where said scraping member is unbiased when said bias means is disposed in said second region; and
(e) a barrier region associated with said ramming member and said scraping member for precluding relative slidable movement between said ramming member and said scraping member when said ramming member is in bearing relationship with said barrier region.

9. The combination recited in claim 8 further comprising a guide means associated with said scraping member and said ramming member for coupling said scraping member and said ramming in fixed rotational relationship while permitting slidable axial relative movement between said scraping member and said ramming member.

10. The combination recited in claim 8 were said scraping member has a distal end and a proximal end, said scraping member further comprising a scraping blade removeably carried by said scraping member adjacent said distal end.

11. The combination recited in claim 9 where said guide means comprises an axially extending slot intermediate said distal and proximal ends of said scraping member and a guide member extending laterally into said said slot, where said guide member is carried in fixed relationship with said ramming member.

12. The combination recited in claim 8 where said partition means comprises a fastener system extending laterally within said ramming member.

13. The combination recited in claim 8 further comprising a handle removeably carried by said ramming member.

14. The combination recited in claim 8 where said bias means comprises a spring.

15. A bias adjustable impact scraping tool for scraping material from surfaces, comprising:
(a) a scraping member having a longitudinal axis;
(b) a ramming member having an axis of elongation mounted in slidable telescopic relationship with said scraping member;
(c) a bias means removeably carried by said ramming memer for axially biasing said scraping member and said ramming member; and
(d) a barrier region associated with said ramming member and said scraping member for precluding relative slidable movement between said ramming member and said scraping member when said ramming member is in bearing relationship with said barrier region.
(e) a handle portion removeably carried by said ramming member for bearing engagement with said bias means so as to place said scraping member and said ramming member in a bias relationship when said bias means is carried by said ramming member and to permit selective removal of said bias means to unbias said scraping and said ramming member.

16. The bias adjustable impact scraping tool recited in claim 15 further comprising a guide means associated with said scraping member and said ramming member for coupling said scraping member and said ramming in fixed rotational relationship while permitting slidable axial relative movement between said scraping member and said ramming member.

17. The bias adjustable impact scraping tool recited in claim 15 were said scraping member has a distal end and a proximal end, said scraping member further comprising a scraping blade removeably carried by said scraping member adjacent said distal end.

18. The bias adjustable impact scraping tool recited in claim 17 where said guide means comprises an axially extending slot intermediate said distal and proximal ends of said scraping member and a guide member extending laterally into said said slot, where said guide member is carried in fixed relationship with said ramming member.

19. The bias adjustable impact scraping tool recited in claim 15 where said bias means comprises a spring.
